(19) United States
(12) Patent Application Publication
(10) Pub. No.: US 2003/0017955 A1
(43) Pub. Date: Jan. 23, 2003

(54) Pouched compositions

(75) Inventors: Peter Jens Forth, Brussels (BE); Veerle Lieve An Vande Vyvere, Ekeren (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/151,272

(22) Filed: May 20, 2002

(30) Foreign Application Priority Data
May 22, 2001 (EP) 01870107.8

(51) Int. Cl. C11D 17/00

(52) U.S. Cl. 510/296; 510/439; 510/505

(57) ABSTRACT

The present invention relates to a pouch composition wherein the pouch is constructed from a water-soluble film and contains a composition comprising a C₅-C₂₀ polyol having at least two polar groups that are separated from each other by at least 5, carbon atoms. The present invention also relates to methods of producing such a pouch composition and to methods of treatment using such a composition. In addition, the present invention relates to the use of a C₅-C₂₀ polyol for aiding the dissolution of a water-soluble pouch.

### CROSS REFERENCE TO RELATED APPLICATIONS

This application claims priority under 35 U.S.C. §119(a) to European Patent Application Serial No. 01870107.8, filed May 22, 2001 (Attorney Docket No. CM2570F).

### FIELD OF THE INVENTION

This invention relates to a pouch composition. In particular, this invention relates to a pouch composition with improved dissolution characteristics.

### BACKGROUND TO THE INVENTION

Cleaning/care compositions come in a number of product forms, such as granules, liquids, tablets, and pouches each form having its own advantages and disadvantages.

Recently, water-soluble pouches containing washing, cleaning or care actives has become popular. In general, the pouches comprise a liquid or powder detergent composition surrounded by a water-soluble film, such a polyvinyl alcohol. These products have the advantage that they are convenient to dose, easy to handle and cause little mess in comparison with traditional detergent forms.

Detergent pouch composition can be dosed directly into the drum or through the dosing drawer. Either way, the composition must be able to disintegrate quickly and completely in order to avoid residue being left in the drawer or in the wash drum. Prior art compositions often do not dissolve as rapidly or as fully as desired. The problem is particularly severe in detergent compositions where, it is believed, that the surfactant molecules pack around the surface of the film preventing rapid dissolution.

It has now been found that the reliability of the dissolution of the pouch compositions is improved with compositions comprising C₅-C₂₀ polyol having at least two polar groups that are separated from each other by at least 5, preferably 6, carbon atoms.

While not wishing to be bound by theory, it is believed that the dissolution of the film material can be retarded by interactions between the actives, such as fabric softening agents or surfactants, and the surface of the film. It is thought that the C₅-C₂₀ polyols of the present invention disrupt this interaction and thus allow for the more rapid dissolution of the film.

### SUMMARY OF THE INVENTION

The present invention relates to a pouch composition wherein the pouch is constructed from a water-soluble film and contains a composition comprising a C₅-C₂₀ polyol having at least two polar groups that are separated from each other by at least 5, carbon atoms. The present invention also relates to methods of producing such a pouch composition and to methods of treatment using such a composition. In addition, the present invention relates to the use of a C₅-C₂₀ polyol for aiding the dissolution of a water-soluble pouch.

More particularly, the C₅-C₂₀ polyol has been found to assist the dissolution of PVA pouches in automatic washing machines in the presence of heavy duty liquid laundry detergent ingredients. This includes such dissolution at low wash temperatures (e.g., 5-30° C.), low water levels (as in wool cycles or crease cycles) short washing times (e.g., 5-50 min.) and in the presence of large amounts of laundry (for example when the washing machine is “stuffed” with laundry.

### DETAILED DESCRIPTION OF THE INVENTION

The pouch herein is typically a closed structure, made of materials described herein, enclosing a volume space. The pouch comprises a composition which can be in any suitable form. The composition must comprise a C₅-C₂₀ polyol having at least two polar groups that are separated from each other by at least 5, preferably 6, carbon atoms. These elements will be described in more detail below.

The pouch and volume space thereof, can be of any form, shape and material which is suitable to hold the composition, e.g. without allowing the release of the composition from the pouch prior to contact of the pouch to water. The exact execution will depend on for example the type and amount of the composition in the pouch, the number of compartments in the pouch, the characteristics required from the pouch to hold, protect and deliver or release the compositions. Preferably, the pouch has a spheroid shape.

Preferred compositions for use in the present invention are cleaning compositions, fabric care compositions, or hard surface cleaners, more preferably laundry or dish washing compositions including, pre-treatment or soaking compositions and other rinse additive compositions. Particularly preferred are laundry detergent compositions, especially liquid detergent compositions.

The pouch may be of such a size that it conveniently contains either a unit dose amount of the composition herein, suitable for the required operation, for example one wash, or only a partial dose, to allow the consumer greater flexibility to vary the amount used, for example depending on the size and/or degree of soiling of the wash load.

The pouch herein can also comprise multiple compartments containing any combination of detergent compositions. If the pouch comprises multiple compartments they will typically be closed structures made of a water-soluble film which encloses a volume space which comprises the components of the detergent composition. Said volume space is preferably enclosed by a water-soluble film in such a manner that the volume space is separated from the outside environment.

Water-Reactive Film

The pouch is typically made from a water-soluble film. It is preferred that the pouch as a whole comprises material which is water-dispersible or more preferably water-soluble. Preferred water-soluble films are polymeric materials, preferably polymers which are formed into a film. The material in the form of a film can for example be obtained by casting, blow-moulding, extrusion or blow extrusion of the polymer material, as known in the art.

The water-soluble films for use herein typically have a solubility of at least 50%, preferably at least 75% or even at least 95%, as measured by the method set out hereinafter using a glass-filter with a maximum pore size of 50 microns, namely:

Gravimetric method for determining water-solubility of the material of the compartment and/or pouch:

50 grams ±0. 1 gram of material is added in a 400 ml beaker, whereof the weight has been determined, and 245 ml ±1 ml of distilled water is added. This is stirred vigorously on magnetic stirrer set at 600 rpm, for 30 minutes. Then, the mixture is filtered through a folded qualitative sintered-glass filter with the pore sizes as defined above (max. 50 micron). The water is dried off from the collected filtrate by any conventional method, and the weight of the remaining polymer is determined (which is the dissolved or dispersed fraction). Then, the percentage solubility or dispersability can be calculated.

It may be preferred that the water soluble film and preferably the pouch as a whole is stretched during formation and/or closing of the pouch, such that the resulting pouch is at least partially stretched. This is to reduce the amount of film required to enclose the volume space of the pouch. When the film is stretched the film thickness decreases. The degree of stretching indicates the amount of stretching of the film by the reduction in the thickness of the film. For example, if by stretching the film, the thickness of the film is exactly halved then the stretch degree of the stretched film is 100%. Also, if the film is stretched so that the film thickness of the stretched film is exactly a quarter of the thickness of the unstretched film then the stretch degree is exactly 200%. Typically and preferably, the thickness and hence the degree of stretching is non-uniform over the pouch, due to the formation and closing process.

Another advantage of using stretching the pouch, is that the stretching action, when forming the shape of the pouch and/or when closing the pouch, stretches the pouch non-uniformly, which results in a pouch which has a non-uniform thickness. This allows control of the dissolution of water-soluble pouches herein, and for example sequential release of the components of the detergent composition enclosed by the pouch to the water.

Preferably, the pouch is stretched such that the thickness variation in the pouch formed of the stretched water-soluble film is from 10 to 1000%, preferably 20% to 600%, or even 40% to 500% or even 60% to 400%. This can be measured by any method, for example by use of an appropriate micrometer. Preferably the pouch is made from a water-soluble film that is stretched, said film has a stretch degree of from 40% to 500%, preferably from 40% to 200%.

The film preferably has a thickness of from 1 μm to 200 μm, more preferably from 15 μm to 150 μm, even more preferably from 30 μm to 100 μm.

Preferred polymer copolymers or derivatives thereof are selected from polyvinyl alcohol (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, most preferably polyvinyl alcohols, polyvinyl alcohol copolymers and hydroxypropyl methyl cellulose (HPMC). Preferably, the level of polymer in the film, for example a PVA polymer, is at least 60%.

The polymer can have any weight average molecular weight, preferably from about 1000 to 1,000,000, or even form 10,000 to 300,000 or even form 15,000 to 200,000 or even form 20,000 to 150,000.

Mixtures of polymers can also be used. This may in particular be beneficial to control the mechanical and/or dissolution properties of the compartment or pouch, depending on the application thereof and the required needs. For example, it may be preferred that a mixture of polymers is present in the material of the compartment, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000 to 40,000, preferably around 20,000, and of PVA or copolymer thereof, with a weight average molecular weight of about 100,000 to 300,000, preferably around 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble.

It may be preferred that the polymer present in the film is from 60-98% hydrolysed, preferably 80% to 90%, to improve the dissolution of the film.

Most preferred films are films which comprise a PVA polymer with similar properties to the film which comprises a PVA polymer and is known under the trade reference M8630, as sold by Chris-Craft Industrial Products of Gary, Ind., US. Another preferred film is known under the trade reference PT-75, sold by Aicello Chemical Europe GmbH, Carl-Zeiss-Strasse 43, 47445 Moers, Del.

The film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful when the composition herein is a detergent composition, that the film itself comprises a detergent additive to be delivered to the wash water, for example organic polymeric soil release agents, dispersants, dye transfer inhibitors.

The pouch herein comprises a composition, typically said composition is contained in the volume space of the pouch.

Composition

Unless stated otherwise all percentages herein are weight percent of the final composition excluding the film.

The pouch comprises a composition which can be in any suitable form such as a liquid, a gel, a solid, or a powder. Preferably, the pouches of the present invention comprise a liquid, a gel, or a powder. More preferably the pouches of the present invention comprise a liquid. If the pouch has multiple compartments the compartments may contain any combination of detergent compositions.

The composition can be cleaning compositions, fabric care compositions, or hard surface cleaners, more preferably laundry or dish washing compositions including, pre-treatment or soaking compositions and other rinse additive compositions. Particularly preferred are laundry detergent compositions.

C₅-C₂₀ Polyols

The composition of the present invention must comprise a C₅-C₂₀ polyol wherein at least two polar groups that are separated from each other by at least 5, preferably 6, carbon atoms.

Preferably, the polyols of the present invention have from 5 to 12, more preferably from 5 to 10, even more preferably from 6 to 8, carbon atoms.

The compositions of the present invention preferably comprise from 0.01% to 15%, more preferably from 0.1% to 10%, even more preferably from 0.25% to 7%, even more preferably still from 0.5% to 5%, by weight of composition, of C₅-C₂₀ polyol.

Examples of suitable polar groups for inclusion in the C₅-C₂₀ polyols include are hydroxyl and carboxyl ions. Preferably the polyols of the present invention have from 2 to 6, more preferably from 2 to 4, even more preferably 2, hydroxy groups per molecule.

Particularly preferred C₅-C₂₀ polyols include:

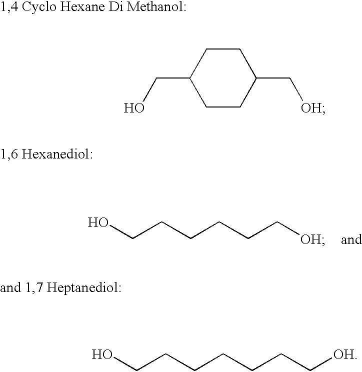

Highly Preferred is 1,4 Cyclo Hexane Di Methanol

Mixtures of these organic molecules or any number of C₅-C₂₀ polyols which comprise two polar groups separated from each other by at least 5, preferably 6, aliphatic carbon atoms are also acceptable. 1,4 Cyclo Hexane Di Methanol may be present in either its cis configuration, its trans configuration or a mixture of both configurations.

These C₅-C₂₀ polyols provide other benefits as well as improving the pouch dissolution properties. For example, they improve the rheology of liquid detergent compositions. It is often difficult to incorporate ethoxylated quaternized amine materials into detergent compositions containing anionic surfactant because the ethoxylated quaternized amine material causes the anionic surfactant to precipitate out of the liquid phase causing the liquid detergent composition to thicken considerably. Nonetheless, it is highly desirable to incorporate these clay soil removal/anti-redeposition agents into a liquid detergent product because they provide important performance benefits. It has been found that by including the C₅-C₂₀ polyols described above the anionic surfactant precipitation and the composition thickening usually observed is avoided and a liquid detergent composition of desirable theological properties is produced.

Hydrotropes

The compositions herein may contain a number of optional ingredients. One highly preferred optional ingredient is a hydrotrope. It has been found that the inclusion of a hydrotrope in the present pouch compositions can further improve dissolution. A hydrotrope is a substance with the ability to increase the solubility of certain slightly soluble organic compounds. A description of hydrotropes for use herein can be found in Surfactant Science, Vol. 67 “Liquid Detergents”, 1997 in Chapter 2 entitled “Hydrotropy”.

Preferably the compositions herein comprise from 0.01% to 15%, more preferably from 0.1% to 10%, even more preferably from 0.25% to 7%, even more preferably still from 0.5% to 5%, by weight of composition, of hydrotrope.

Preferred hydrotropes are selected from sodium cumene sulphonate, sodium xylene sulphonate, sodium naphthalene sulphonate, sodium p-toluene sulphonate, and mixtures thereof. Especially preferred is sodium cumene sulphonate. While the sodium form of the hydrotrope is preferred, the potassium, ammonium, alkanolammonium, and/or C₂-C₄ alkyl substituted ammonium forms can also be used.

Preferably, the compositions herein comprise C₅-C₂₀ polyol and hydrotrope in the ratio of from 10:1 to 1:10, more preferably from 5:1 to 1:5, even more preferably from 2:1 to 1:2.

Therefore, a highly preferred embodiment of the present invention comprises 1,4 Cyclo Hexane Di Methanol and sodium cumene sulphonate in ratios of from 2:1 to 1:2.

Preferred Embodiments

Preferably the composition of the present invention is a liquid composition and is contained in the inner volume space of the pouch, or it may be divided over one or more compartments of the pouch.

The liquid composition can comprise up to 9% by weight water, preferably 1% to 8% or even 2% to 7.5% or even 3% to 6% or even 5% by weight of the composition. This is on basis of free water, added to the other ingredients of the composition.

The liquid composition can made by any method and can have any viscosity, typically depending on its ingredients. The liquid composition preferably has a viscosity of 50 to 10000 cps (centipoises), as measured at a rate of 20 s⁻¹, more preferably from 300 to 3000 cps or even from 400 to 600 cps. The compositions herein can be Newtonian or non-Newtonian.

The liquid composition preferably has a density of 0.8 kg/l to 1.3 kg/l, preferably around 1.0 to 1.1 kg/l.

If the composition is a liquid detergent composition, it is preferred that at least a surfactant and builder are present, preferably at least anionic surfactant and preferably also nonionic surfactant, and preferably at least water-soluble builder, preferably at least phosphate builder or more preferably at least fatty acid builder.

Preferred is also the presence of enzymes and preferred may also be to incorporate a bleaching agent, such as a preformed peroxyacid.

The liquid composition comprises preferably a colorant or dye and/or pearlescence agent.

Highly preferred are also perfume, brightener, buffering agents (to maintain the pH preferably from 5.5 to 9, more preferably 6 to 8), fabric softening agents, including clays and silicones benefit agents, suds suppressors.

In hard-surface cleaning compositions and dish wash compositions, it is preferred that at least a water-soluble builder is present, such as a phosphate, and preferably also surfactant, perfume, enzymes, bleach.

In fabric enhancing compositions, preferably at least a perfume and a fabric benefit agent are present for example a cationic softening agent, or clay softening agent, anti-wrinkling agent, fabric substantive dye.

Highly preferred in all above compositions are also additional solvents, such as alcohols, diols, monoamine derivatives, glycerol, glycols, polyalkylane glycols, such as polyethylene glycol. Highly preferred are mixtures of solvents, such as mixtures of alcohols, mixtures of diols and alcohols, mixtures. Highly preferred may be that (at least) an alcohol, diol, monoamine derivative and preferably even glycerol are present. The compositions of the invention are preferably concentrated liquids having preferably less than 50% or even less than 40% by weight of solvent, preferably less than 30% or even less than 20% or even less than 35% by weight. Preferably the solvent is present at a level of at least 5% or even at least 10% or even at least 15% by weight of the composition.

Highly preferred is that the composition comprises, in addition to water, a plasticiser for the water-soluble pouch material, for example one of the plasticisers described above, for example glycerol. Such plasticisers can have the dual purpose of being a solvent for the other ingredients of the composition and a plasticiser for the pouch material.

C₁-C₄ Alcohol

Preferably the compositions herein also contain a C₁-C₄ alcohol. Preferred is ethanol. The C₁-C₄ alcohol is preferably at a level of from 0.01% to 30%, more preferably from 0.1% to 10%.

Surfactant

The detergent compositions of the invention comprise preferably a surfactant system. Preferably, at least an anionic surfactant is present, preferably at least an sulphonic acid surfactant, such as a linear alkyl benzene sulphonic acid, but salt forms may also be used. Preferably, at least 15%, more preferably at least 20%, even more preferably at least 30%, by weight of the composition is a surfactant, preferably less than 70%, more preferably less than 60%, even more preferably less than 50%, by weight of compositions is surfactant. Preferably, at least an anionic surfactant and an nonionic surfactant are present in the surfactant system of the composition, preferably in a ratio of 1:2 to 2:1, preferably 1.5:1 to 1:1.5.

The anionic surfactant(s), are preferably present at a level of at least 7.5% by weight of the composition. More preferably anionic surfactant is present at a level of from 10% or even at least 15%, or even from 22.5% by weight of the composition.

Anionic sulfonate or sulfonic acid surfactants suitable for use herein include the acid and salt forms of a C5-C20, more preferably a C10-C16, more preferably a C11-C13 alkylbenzene sulfonates, alkyl ester sulfonates, C6-C22 primary or secondary alkane sulfonates, sulfonated polycarboxylic acids, and any mixtures thereof, but preferably C11-C13 alkylbenzene sulfonates.

Anionic sulphate salts or acids surfactants suitable for use in the compositions of the invention include the primary and secondary alkyl sulphates, having a linear or branched alkyl or alkenyl moiety having from 9 to 22 carbon atoms or more preferably C12-C18 alkyl.

Highly preferred are beta-branched alkyl sulphate surfactants or mixtures of commercial available materials, having a weight average (of the surfactant or the mixture) branching degree of at least 50% or even at least 60% or even at least 80% or even at least 95%. It has been found that these branched sulphate surfactants provide a much better viscosity profile, when clays are present, particular when 5% or more clay is present.

It may be preferred that the only sulphate surfactant is such a highly branched alkyl sulphate surfactant, namely referred may be that only one type of commercially available branched alkyl sulphate surfactant is present, whereby the weight average branching degree is at least 50%, preferably at least 60% or even at least 80%, or even at least 90%. Preferred is for example Isalchem, as available form Condea.

Mid-chain branched alkyl sulphates or sulfonates are also suitable anionic surfactants for use in the compositions of the invention. Preferred are the mid-chain branched alkyl sulphates. Preferred mid-chain branched primary alkyl sulphate surfactants are of the formula

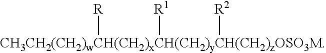

These surfactants have a linear primary alkyl sulphate chain backbone (i.e., the longest linear carbon chain which includes the sulphated carbon atom), which preferably comprises from 12 to 19 carbon atoms and their branched primary alkyl moieties comprise preferably a total of at least 14 and preferably no more than 20, carbon atoms. In compositions or components thereof of the invention comprising more than one of these sulphate surfactants, the average total number of carbon atoms for the branched primary alkyl moieties is preferably within the range of from greater than 14.5 to about 17.5. Thus, the surfactant system preferably comprises at least one branched primary alkyl sulphate surfactant compound having a longest linear carbon chain of not less than 12 carbon atoms or not more than 19 carbon atoms, and the total number of carbon atoms including branching must be at least 14, and further the average total number of carbon atoms for the branched primary alkyl moiety is within the range of greater than 14.5 to about 17.5.

Preferred mono-methyl branched primary alkyl sulphates are selected from the group consisting of: 3-methyl pentadecanol sulphate, 4-methyl pentadecanol sulphate, 5-methyl pentadecanol sulphate, 6-methyl pentadecanol sulphate, 7-methyl pentadecanol sulphate, 8-methyl pentadecanol sulphate, 9-methyl pentadecanol sulphate, 10-methyl pentadecanol sulphate, 11-methyl pentadecanol sulphate, 12-methyl pentadecanol sulphate, 13-methyl pentadecanol sulphate, 3-methyl hexadecanol sulphate, 4-methyl hexadecanol sulphate, 5-methyl hexadecanol sulphate, 6-methyl hexadecanol sulphate, 7-methyl hexadecanol sulphate, 8-methyl hexadecanol sulphate, 9-methyl hexadecanol sulphate, 10-methyl hexadecanol sulphate, 11-methyl hexadecanol sulphate, 12-methyl hexadecanol sulphate, 13-methyl hexadecanol sulphate, 14-methyl hexadecanol sulphate, and mixtures thereof.

Preferred di-methyl branched primary alkyl sulphates are selected from the group consisting of: 2,3-methyl tetradecanol sulphate, 2,4-methyl tetradecanol sulphate, 2,5-methyl tetradecanol sulphate, 2,6-methyl tetradecanol sulphate, 2,7-methyl tetradecanol sulphate, 2,8-methyl tetradecanol sulphate, 2,9-methyl tetradecanol sulphate, 2,10-methyl tetradecanol sulphate, 2,11-methyl tetradecanol sulphate, 2,12-methyl tetradecanol sulphate, 2,3-methyl pentadecanol sulphate, 2,4-methyl pentadecanol sulphate, 2,5-methyl pentadecanol sulphate, 2,6-methyl pentadecanol sulphate, 2,7-methyl pentadecanol sulphate, 2,8-methyl pentadecanol sulphate, 2,9-methyl pentadecanol sulphate, 2,10-methyl pentadecanol sulphate, 2,11-methyl pentadecanol sulphate, 2,12-methyl pentadecanol sulphate, 2,13-methyl pentadecanol sulphate, and mixtures thereof.

It is preferred that the anionic surfactants herein are present in the form of sodium salts.

Nonionic Alkoxylated Surfactant

Essentially any alkoxylated nonionic surfactants, which is not an alkoxylated amine, imine, amide or imide compound of the invention, can be comprised by the composition herein. Thus, these nonionic surfactants are then present in addition to the alkoxylated polymer compound of the invention. Ethoxylated and propoxylated nonionic surfactants are preferred. Preferred alkoxylated surfactants can be selected from the classes of the nonionic condensates of alkyl phenols, nonionic ethoxylated alcohols, nonionic ethoxylated/propoxylated fatty alcohols.

Highly preferred are nonionic alkoxylated alcohol surfactants, being the condensation products of aliphatic alcohols with from 1 to 75 moles of alkylene oxide, in particular about 50 or from 1 to 15 moles, preferably to 11 moles, particularly ethylene oxide and/or propylene oxide, are highly preferred nonionic surfactants. The alkyl chain of the aliphatic alcohol can either be straight or branched, primary or secondary, and generally contains from 6 to 22 carbon atoms. Particularly preferred are the condensation products of alcohols having an alkyl group containing from 8 to 20 carbon atoms with from 2 to 9 moles and in particular 3 or 5 moles, of ethylene oxide per mole of alcohol.

Polyhydroxy fatty acid amides are highly preferred nonionic surfactant comprised by the composition, in particular those having the structural formula R²CONR¹Z wherein :R¹ is H, C₁₋₁₈, preferably C₁-C₄ hydrocarbyl, 2-hydroxy ethyl, 2-hydroxy propyl, ethoxy, propoxy, or a mixture thereof, preferable C₁-C₄ alkyl, more preferably C₁ or C₂ alkyl, most preferably C₁ alkyl (i.e., methyl); and R² is a C₅-C₃, hydrocarbyl, preferably straight-chain C₅-C₁₉ or C₇-C₁₉ alkyl or alkenyl, more preferably straight-chain C₉-C₁₇ alkyl or alkenyl, most preferably straight-chain C₁₁-C₁₇ alkyl or alkenyl, or mixture thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar in a reductive amination reaction; more preferably Z is a glycityl.

Cationic Surfactant

Preferred are also cationic mono-alkoxylated and bis-alkoxylated quaternary amine surfactants with a C₆-C₁₈ N-alkyl chain, such as of the general formula I:

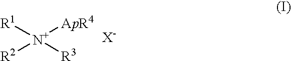

wherein R¹ is an alkyl or alkenyl moiety containing from about 6 to about 18 carbon atoms, preferably 6 to about 16 carbon atoms, most preferably from about 6 to about 14 carbon atoms; R² and R³ are each independently alkyl groups containing from one to about three carbon atoms, preferably methyl, most preferably both R² and R³ are methyl groups; R⁴ is selected from hydrogen (preferred), methyl and ethyl; X⁻ is an anion such as chloride, bromide, methylsulphate, sulphate, or the like, to provide electrical neutrality; A is a alkoxy group, especially a ethoxy, propoxy or butoxy group; and p is from 0 to about 30, preferably 2 to about 15, most preferably 2 to about 8.

The cationic bis-alkoxylated amine surfactant preferably has the general formula II:

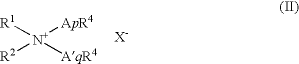

wherein R¹ is an alkyl or alkenyl moiety containing from about 8 to about 18 carbon atoms, preferably 10 to about 16 carbon atoms, most preferably from about 10 to about 14 carbon atoms; R² is an alkyl group containing from one to three carbon atoms, preferably methyl; R³ and R⁴ can vary independently and are selected from hydrogen (preferred), methyl and ethyl, X⁻ is an anion such as chloride, bromide, methylsulphate, sulphate, or the like, sufficient to provide electrical neutrality. A and A′ can vary independently and are each selected from C1-C4 alkoxy, especially ethoxy, (i.e., —CH₂CH₂O—), propoxy, butoxy and mixtures thereof; p is from 1 to about 30, preferably 1 to about 4 and q is from 1 to about 30, preferably 1 to about 4, and most preferably both p and q are 1.

Another suitable group of cationic surfactants which can be used in the detergent compositions are cationic ester surfactants. Suitable cationic ester surfactants, including choline ester surfactants, have for example been disclosed in U.S. Pat. Nos. 4,228,042, 4,239,660 and 4,260,529.

Builder Compounds

The compositions in accord with the present invention preferably contain a water-soluble builder compound, typically present in detergent compositions at a level of from 1% to 60% by weight, preferably from 3% to 40% by weight, most preferably from 5% to 25% by weight of the composition.

Suitable water-soluble builder compounds include the water soluble monomeric carboxylates, or their acid forms, or homo or copolymeric polycarboxylic acids or their salts in which the polycarboxylic acid comprises at least two carboxylic radicals separated from each other by not more that two carbon atoms, and mixtures of any of the foregoing.

Preferred builder compounds include citrate, tartrate, succinates, oxydissuccinates, carboxymethyloxysuccinate, nitrilotriacetate, and mixtures thereof.

Highly preferred maybe that one or more fatty acids and/or optionally salts thereof (and then preferably sodium salts) are present in the detergent composition. It has been found that this can provide further improved softening and cleaning of the fabrics. Preferably, the compositions contain 1% to 25% by weight of a fatty acid or salt thereof, more preferably 6% to 18% or even 10% to 16% by weight. Preferred are in particular C₁₂-C₁₈ saturated and/or unsaturated, linear and/or branched, fatty acids, but preferably mixtures of such fatty acids. Highly preferred have been found mixtures of saturated and unsaturated fatty acids, for example preferred is a mixture of rape seed-derived fatty acid and C₁₆-C₁₈ topped whole cut fatty acids, or a mixture of rape seed-derived fatty acid and a tallow alcohol derived fatty acid, palmitic, oleic, fatty alkylsuccinic acids, and mixtures thereof.

The detergent compositions of the invention may comprise phosphate-containing builder material. Preferably present at a level of from 2% to 40%, more preferably from 3% to 30%, more preferably from 5% to 20%. Suitable examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerization ranges from about 6 to 21, and salts of phytic acid.

The compositions in accord with the present invention may contain a partially soluble or insoluble builder compound, typically present in detergent compositions at a level of from 0.5% to 60% by weight, preferably from 5% to 50% by weight, most preferably from 8% to 40% weight of the composition.

Preferred are aluminosilicates and/or crystalline layered silicates such as SKS-6, available from Clariant.

However, from a formulation point of view it may be preferred not to include such builders in the liquid composition, because it will lead to too much dispersed or precipitate material in the liquid, or it requires too much process or dispersion aids.

Perfume

Highly preferred are perfume components, preferably at least one component comprising a coating agent and/or carrier material, preferably organic polymer carrying the perfume or alumniosilicate carrying the perfume, or an encapsulate enclosing the perfume, for example starch or other cellulosic material encapsulate. The inventors have found that the perfumes are more efficiently deposited onto the fabric in the compositions of the invention.

Preferably the pouch compositions of the present invention comprise from 0.01% to 4% of perfume, more preferably from 0.1% to 2%.

Fabric Softening Clays

Preferred fabric softening clays are smectite clays, which can also be used to prepare the organophilic clays described hereinafter, for example as disclosed in EP-A-299575 and EP-A-313146. Specific examples of suitable smectite clays are selected from the classes of the bentonites- also known as montmorillonites, hectorites, volchonskoites, nontronites, saponites and sauconites, particularly those having an alkali or alkaline earth metal ion within the crystal lattice structure. Preferably, hectorites or montmorillonites or mixtures thereof. Hectorites are most preferred clays.

The softening clay is preferably present at levels up to 15%, more preferably up to 7% or even up to 10% by weight, typically, at least 3% or even at least 5%. By weight, when the formulation is to be a softening formulation.

The hectorite clays suitable in the present composition should preferably be sodium clays, for better softening activity.

Examples of hectorite clays suitable for the present compositions include Bentone EW as sold by Elementis.

Another preferred clay is an organophilic clay, preferably a smectite clay, whereby at least 30% or even at least 40% or preferably at least 50% or even at least 60% of the exchangeable cations is replaced by a, preferably long-chain, organic cations. Such clays are also referred to as hydrophobic clays. The cation exchange capacity of clays and the percentage of exchange of the cations with the long-chain organic cations can be measured in several ways known in the art, as for example fully set out in Grimshaw, The Chemistry and Physics of Clays, Interscience Publishers, Inc.,pp. 264-265 (1971).

Preferred organophilic clays herein clay are smectite clays, preferably hectorite clays and/or montmorillonite clays containing one or more organic cations of formulae:

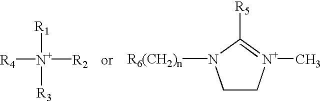

where R₁ represents an organic radical selected from R₇, R₇—CO—O—(CH₂)ₙ, or

R₇—CO—NR₈— in which R₇ is an alkyl, alkenyl or alkylaryl group with 12-22 carbon atoms, whereby R₈ is hydrogen, C₁-C₄ alkyl, alkenyl or hydroxyalkyl, preferably —CH₃ or —C₂H₅ or —H; n is an integer, preferably equal to 2 or 3; R₂ represents an organic radical selected from R₁ or C₁-C₄ alkyl, alkenyl or hydroxyalkyl, preferably —CH₃ or —CH₂CH₂OH; R₃ and R₄ are organic radicals selected from C₁-C₄ alkyl-aryl, C₁-C₄ alkyl, alkenyl or hydroxyalkyl, preferably —CH₃, —CH₂CH₂OH, or benzyl group; R₅ is an alkyl or alkenyl group with 12-22 carbon atoms; R₆ is preferably —OH, —NHCO—R₇, or —OCO—R₇.

Highly preferred are organophilic clays as available from Rheox/Elementis, such as Bentone SD-1 and Bentone SD-3, which are registered trademarks of Rheox/Elementis.

Cationic Fabric Softening Agents

Cationic fabric softening agents can be present in the composition herein. Suitable cationic fabric softening agents include the water insoluble tertiary amines or dilong chain amide materials as disclosed in GB-A-1 514 276 and EP-B-0 011 340. Preferably, these water-insoluble tertiary amines or dilong chain amide materials are comprised by the solid component of the composition herein.

Cationic fabric softening agents are typically incorporated at total levels of from 0.5% to 15% by weight, normally from 1% to 5% by weight.

Bleaching Agent

Another ingredient which may be present is a perhydrate bleach, such as salts of percarbonates, particularly the sodium salts, and/or organic peroxyacid bleach precursor, and/or transition metal bleach catalysts, especially those comprising Mn or Fe. It has been found that when the pouch or compartment is formed from a material with free hydroxy groups, such as PVA, the preferred bleaching agent comprises a percarbonate salt and is preferably free form any perborate salts or borate salts. It has been found that borates and perborates interact with these hydroxy-containing materials and reduce the dissolution of the materials and also result in reduced performance.

Inorganic perhydrate salts are a preferred source of peroxide. Examples of inorganic perhydrate salts include percarbonate, perphosphate, persulfate and persilicate salts. The inorganic perhydrate salts are normally the alkali metal salts. Alkali metal percarbonates, particularly sodium percarbonate are preferred perhydrates herein.

The composition herein preferably comprises a peroxy acid or a precursor therefor (bleach activator), preferably comprising an organic peroxyacid bleach precursor. It may be preferred that the composition comprises at least two peroxy acid bleach precursors, preferably at least one hydrophobic peroxyacid bleach precursor and at least one hydrophilic peroxy acid bleach precursor, as defined herein. The production of the organic peroxyacid occurs then by an in-situ reaction of the precursor with a source of hydrogen peroxide. The hydrophobic peroxy acid bleach precursor preferably comprises a compound having a oxy-benzene sulphonate group, preferably NOBS, DOBS, LOBS and/or NACA-OBS, as described herein. The hydrophilic peroxy acid bleach precursor preferably comprises TAED.

Amide substituted alkyl peroxyacid precursor compounds can be used herein. Suitable amide substituted bleach activator compounds are described in EP-A-0170386.

The composition may contain a pre-formed organic peroxyacid. A preferred class of organic peroxyacid compounds are described in EP-A-170,386. Other organic peroxyacids include diacyl and tetraacylperoxides, especially diperoxydodecanedioc acid, diperoxytetradecanedioc acid and diperoxyhexadecanedioc acid. Mono- and diperazelaic acid, mono- and diperbrassylic acid and N-phthaloylaminoperoxicaproic acid are also suitable herein.

Suds Suppressing System

The composition may comprise a suds suppresser at a level less than 10%, preferably 0.001% to 10%, preferably from 0.01% to 8%, most preferably from 0.05% to 5%, by weight of the composition Preferably the suds suppresser is either a soap, paraffin, wax, or any combination thereof. If the suds suppresser is a suds suppressing silicone, then the detergent composition preferably comprises from 0.005% to 0.5% by weight a suds suppressing silicone. Suitable suds suppressing systems for use herein may comprise essentially any known antifoam compound, including for example silicone antifoam compounds and 2-alkyl alcanol antifoam compounds.

Other suitable antifoam compounds include the monocarboxylic fatty acids and soluble salts thereof, as also described as builders above. These materials are described in U.S. Pat. No. 2,954,347, issued Sep. 27, 1960 to Wayne St. John. The monocarboxylic fatty acids, and salts thereof, for use as suds suppressor typically have hydrocarbyl chains of 10 to 24 carbon atoms, preferably 12 to 18 carbon atoms. Suitable salts include the alkali metal salts such as in particular sodium but also potassium salts.

Enzymes

Another preferred ingredient useful in the compositions herein is one or more enzymes.

Suitable enzymes include enzymes selected from peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, lipase.

Enzymes are generally incorporated in detergent compositions at a level of from 0.0001% to 2%, preferably from 0.001% to 0.2%, more preferably from 0.005% to 0.1% pure enzyme by weight of the composition.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimize their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application. In regard of enzyme stability in liquid detergents, attention should be focused on amino acids sensitive to oxidation in the case of bleach stability and on surface charges for the surfactant compatibility. The isoelectric point of such enzymes may be modified by the substitution of some charged amino acids. The stability of the enzymes may be further enhanced by the creation of e.g. additional salt bridges and enforcing metal binding sites to increase chelant stability. Furthermore, enzymes might be chemically or enzymatically modified, e.g. PEG-ylation, cross-linking and/or can be immobilized, i.e. enzymes attached to a carrier can be applied.

The enzyme to be incorporated in a detergent composition can be in any suitable form, e.g. liquid, encapsulate, prill, granulate . . . or any other form according to the current state of the art.

Organic Polymeric Compounds

Useful additional non-alkoxylated organic polymeric compounds for inclusion in the compositions herein include the water soluble organic homo- or co-polymeric polycarboxylic acids or their salts in which the polycarboxylic acid comprises at least two carboxyl radicals separated from each other by not more than two carbon atoms. Polymers of the latter type are disclosed in GB-A-1,596,756. Examples of such salts are polyacrylates of MWt 1000-5000 and their copolymers with maleic anhydride, such copolymers having a molecular weight of from 2000 to 100,000, especially 40,000 to 80,000.

Other organic polymeric compounds suitable for incorporation in the detergent compositions herein include cellulose derivatives.

Dye-Transfer Inhibitors

The compositions herein may also comprise from 0.01% to 10%, preferably from 0.05% to 0.5% by weight of polymeric dye transfer inhibiting agents. The polymeric dye transfer inhibiting agents are preferably selected from polyamine N-oxide polymers, copolymers of N-vinylpyrrolidone and N-vinylimidazole, polyvinylpyrrolidonepolymers or combinations thereof, whereby these polymers can be cross-linked polymers.

Brighteners

The compositions herein also optionally contain from about 0.005% to 5% by weight of certain types of hydrophilic optical brighteners.

Preferred brighteners include 4,4′,-bis[(4-anilino-6-(N-2-bis-hydroxyethyl)-s-triazine-2-yl)amino]-2,2′-stilbenedisulfonic acid and disodium salt, commercially marketed under the tradename Tinopal-UNPA-GX by Ciba-Geigy Corporation; 4,4′-bis[(4-anilino-6-(N-2-hydroxyethyl-N-methylamino)-s-triazine-2-yl)amino]2,2′-stilbene disulfonic acid disodium salt, commercially marketed under the tradename Tinopal 5BM-GX by Ciba-Geigy Corporation; 4,4′-bis[(4-anilino-6-morphilino-s-triazine-2-yl)amino]2,2′-stilbenedisulfonic acid, sodium salt, commercially marketed under the tradename Tinopal-DMS-X and Tinopal AMS-GX by Ciba Geigy Corporation.

Alkoxylated Amine, Imine, Amide Imide Compound

The composition can comprise one or more alkoxylated compounds having at least two alkoxylated amine, imine, amide or imide groups.

Preferred are compounds having at least two alkoxylated amine groups.

The alkoxylation group may have one or more alkoxylates, typically more than one, thus forming a chain of alkoxylates, or polyalkoxylation group.

The compound may have two alkoxylation groups or chain, preferably at least 4 or even at least 7 or even at least 10 or even at least 16. Preferred is that the alkoxylation groups are polyalkoxylation groups, (each independently) having an average alkoxylation degree of at least 5, more preferably at least 8, preferably at least 12, up to preferably 80 or even to 50 or even to 25.

The (poly)alkoxylation is preferably a (poly)ethoxylation and/or (poly)propoxylation. Thus, preferred is that the alkoxylation group is a polyethoxylation group or polypropoxylation group, or a (poly)ethoxylation/(poly)propoxyltion group

Preferred may be that these compounds are polymers having such groups. When used herein an polymer is a compound having 2 or more repeating monomer units forming a backbone. The alkoxylated polymer herein is preferably such that the alkoxylation groups are not part of the backbone of the polymer, but are alkoxylation groups of the amine, imine, amide or imide in the units forming the backbone, or are alkoxylation groups of other side-groups chemically bound to the backbone.

Said alkoxylated compound is preferably a polyamide, polyimide or more preferably a polyamine or polyime compound, whereby these amide, imide, amine or imine units are present as backbone of the polymer, forming the chain of repeating units. Preferably, these polymers have at least 3 or even 4 or even 5 amide, imide, amine or imine units. Hereby, it may be preferred that only some of the amine or imine are alkoxylated.

It may be preferred that the backbone has also side-chains containing amide, imide, amine or imine groups, which may be alkoxylated.

Preferred are compounds having a weight average molecular weight of 200 to 50,000, preferably to 20,000 or even to 10,000, or even from 350 to 5000 or even to 2000 or even to 1000.

Preferably the composition herein (described in more detail hereinafter) comprises (by weight of the composition) from 0.5% to 15%, more preferably from 0.8% to 10%, more preferably form 1.5% to 8%, more preferably from 2.0% or even 2.5% or even 3% to 6% of said alkoxylated compound. The composition herein may comprise preferably mixtures of the specified compounds.

Highly preferred are ethoxylated poly(ethyleneimine), preferably having an average ethoxylationd degree per ethoxylation chain of 15 to 25, and a molecular weight of 1000-2000 dalton. Also highly preferred are ethoxylated tetraethylene pentaimines.

Chelating Agents

The composition herein can comprise a chelating agent, for example, having two or more phosphonic acid or phosphonate groups, or two or more carboxylic acid or carboxylate groups, or mixtures thereof. By chelating agent it is meant herein components which act to preferentially sequester (chelate) heavy metal ions, but these components may also have calcium and magnesium chelation capacity.

Chelating agents are generally present at a level of from 1%, preferably from 2.5% from 3.5% or even 5.0% or even 7% and preferably up to 20% or even 15% or even 10% by weight of the composition herein.

Highly suitable organic phosphonates herein are amino alkylene poly (alkylene phosphonates), alkali metal ethane 1-hydroxy bisphosphonates and nitrilo trimethylene phosphonates. Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate.

Other suitable chelating agents for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof. Especially preferred is ethylenediamine-N,N′-disuccinic acid (EDDS) or the alkali metal, alkaline earth metal, ammonium, or substituted ammonium salts thereof, or mixtures thereof. Glycinamide-N,N′-disuccinic acid (GADS), ethylenediamine-N-N′-diglutaric acid (EDDG) and 2-hydroxypropylenediamine-N-N′-disuccinic acid (HPDDS) are also suitable.

Suitable chelating agents with two or more carboxylates or carboxylic acid groups include the acid or salt forms of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Chelants containing three carboxy groups include, in particular, the acids or salt forms of citrates, aconitrates and citraconates as well as succinate derivatives. Preferred carboxylate chelants are hydroxycarboxylates containing up to three carboxy groups per molecule, more particularly citrates and citric acids.

Chelating agents containing four carboxy groups include the salts and acid forms of oxydisuccinates, 1,1,2,2-ethane tetracarboxylates, 1,1,3,3-propane tetracarboxylates and 1,1,2,3-propane tetracarboxylates, sulfosuccinate derivatives.

Highly preferred it that at least one organo phosphonate or phosphonic acid and also at least one di- or tri-carboxylate or carboxylic acid is present. Highly preferred is that at least fumaric acid (or salt) and citric acid (or salt) and one or more phosphonates are present. Preferred salts are sodium salts.

Other Optional Ingredients

Other optional ingredients suitable for inclusion in the composition herein include colours, opacifiers, anti-oxidants, bactericides, neutralizing agents, buffering agents, phase regulants, thickeners such as hydrogenated castor oil and filler salts, with sodium sulphate being a preferred filler salt.

Use of C₅-C₂₀ Polyols

The present invention also includes the use of a C₅-C₂₀ polyol for aiding the dissolution of a water-soluble pouch.

Laundry Washing Method

Preferably the pouch composition of the present invention is used for cleaning or care of laundry. Preferably, the pouch dissolves or disintegrates in water to deliver the detergent ingredients to the washing cycle. Typically, the pouch is added to the dispensing drawer, or alternatively to the drum, of an automatic washing machine.

Preferably, the pouch comprises all of the detergent ingredients of the detergent composition used in the washing. Although it may be preferred that some detergent ingredients are not comprised by the pouch and are added to the washing cycle separately. In addition, one or more detergent compositions other than the detergent composition comprised by the pouch can be used during the laundering process, such that said detergent composition comprised by the multi-compartment pouch is used as a pre-treatment, main-treatment, post-treatment or a combination thereof during such a laundering process.

### EXAMPLES

### Example I

A piece of plastic is placed in a mould to act as a false bottom. The mould consists of a cylindrical shape and has a diameter of 45 mm and a depth of 25 mm. A 1 mm thick layer of rubber is present around the edges of the mould. The mould has some holes in the mould material to allow a vacuum to be applied. With the false bottom in place the depth of the mould is 12 mm. A piece of Chris-Craft M-8630 film is placed on top of this mould and fixed in place. A vacuum is applied to pull the film into the mould and pull the film flush with the inner surface of the mould and the false bottom. 50 ml of the liquid component of a detergent composition is poured into the mould. Next, a second piece of Chris-Craft M-8630 film is placed over the top of the mould with the liquid component and sealed to the first piece of film by applying an annular piece of flat metal of an inner diameter of 46 mm and heating that metal under moderate pressure onto the ring of rubber at the edge of the mould to heat-seal the two pieces of film together to form a compartment comprising the liquid component. The metal ring is typically heated to a temperature of from 135° C. to 150° C. and applied for up to 5 seconds.

### Examples II-V

Pouches are made by the process described in Example I which comprise the following compositions:

| | II | III | IV | V |
|---|---|---|---|---|
| | % wt | % wt | % wt | % wt |
| Dodecylbenzene sulphonic acid | 22.0 | 22.0 | 15.0 | 29.0 |
| C₈-C₁₀ amido propyl | 1.5 | 2.0 | 1.0 | 1.8 |
| dimethylamine | | | | |
| Alkyl alcohol, 7 times | 15.0 | 22.0 | 20.0 | 0 |
| ethoxylated | | | | |
| Neodol 23-9 | 0 | 0 | 0 | 21.0 |
| Citric Acid | 1.5 | 1.5 | 1.5 | 2.5 |
| Double cut whole palm kernel | 15.0 | 20 | 10.0 | 5.0 |
| fatty acid | | | | |
| Protease | 1.0 | 1.0 | 1.0 | 2.5 |
| Amylase | 0.1 | 0.2 | 0.2 | 0.3 |
| Glycosidase | 0.10 | 0.10 | 0.10 | 0 |
| Formic acid | 1.1 | 1.1 | 1.1 | 1.1 |
| Calcium chloride | 0.02 | 0.02 | 0.02 | 0 |
| Calcium formate | 0 | 0 | 0 | 0.1 |
| Ethoxylated tetra ethylene | 1.5 | 1.5 | 1.5 | 1.0 |
| pentamine | | | | |
| Polyethyleneimine ethoxylate | 1.5 | 1.5 | 1.5 | 2.5 |
| Diethylene triamine penta | 0.9 | 0.9 | 0.9 | 0 |
| methylene phosphonic acid | | | | |
| Diethylene triamine penta acetic | 0 | 0 | 0 | 0.2 |
| acid | | | | |
| Brightener | 0.3 | 0.3 | 0.3 | 0.2 |
| Perfume | 1.7 | 1.7 | 1.7 | 0.8 |
| Colorant: Acid Blue #1 (Turq | 0.0006 | 0.0006 | 0.0006 | 0.003 |
| EVS) | | | | |
| Sodium hydroxide | 0 | 0 | 0 | 0 |
| Mono ethanolamine | 11.0 | 11.0 | 11.0 | 10.4 |
| Sodium cumene sulphonate | 0 | 0.2 | 1.0 | |
| Cyclohexane 1,4 dimethanol | 5.0 | 2.5 | 1.0 | 2.5 |
| Hydrophilic diol (1,2- | 15.0 | 10.0 | 14.0 | 14.1 |
| propanediol) | | | | |
| Water | 3.6 | 3.6 | 4.8 | 5.0 |
| Miscellianeous: up to 100 parts | | | | |

### Examples VI-VIII

Pouches are made by filling and sealing containers made from 76 micron PVA film (Monosol or Aicello) with 50 ml of the following compositions:

| | VI | VII | VIII |
|---|---|---|---|
| | % wt | % wt | % wt |
| C11-C13 linear | 22.0 | 13.0 | 19.0 |
| alkylbenzene | | | |
| sulphonic acid | | | |
| C₈-C₁₀ amido | 0.0 | 0.0 | 1.0 |
| propyldimethylamine | | | |
| C12-C14 alcohol, | 15.0 | 22.0 | 20.0 |
| 2-8 times ethoxylated | | | |
| C12-C16 AE1-3S | 0.0 | 4.0 | 3.0 |
| Polycarboxylate | 1.50 | 3.0 | |
| builder (MW <500) | | | |
| C16-C18 saturated | 15.0 | 20 | 5.0 |
| or unsaturated | | | |
| fatty acid | | | |
| Detergent enzyme | 1.2 | 2.0 | 0.5 |
| mixture | | | |
| (Protease, Amylase) | | | |
| Enzyme stabilizer | 1.2 | 0.7 | 0 |
| Polymeric dispersant | 3 | 2 | 1 |
| (Ethoxylated tetra | | | |
| ethylene | | | |
| pentamine and | | | |
| Polyethyleneimine | | | |
| ethoxylate in a | | | |
| 1:1 wt-ratio) | | | |
| Chelant I (Phosphorus- | 1.0 | 0.5 | 0.4 |
| free) | | | |
| Chelant II | 0 | 0 | 0.6 |
| (Phosphorus- | | | |
| containing) | | | |
| Brightener | 0.1 | 0.3 | 0.2 |
| Perfume | 0.7 | 2 | 1 |
| Colorant | 0.001 | 0.0005 | 0.005 |
| Sodium cumene | 0 | 0 | 0 |
| sulphonate | | | |
| Cyclohexane 1,4 | 4 | 4 | 4 |
| dimethanol | | | |
| Hydrophilic diol | 15.0 | 10.0 | 0 |
| (1,2-propanediol) | | | |
| Alternate hydrophilic | 0 | 5 | 15.0 |
| diol (Glycerol) | | | |
| Mono ethanolamine | To pH 8.5 | To pH 8 | To pH 7.5 |
| and/or Sodium | | | |
| hydroxide | | | |
| Water and | up to 100 parts | up to 100 parts | up to 100 parts |
| Miscelllaneous: up to | | | |
| 100 parts | | | |

What is claimed is:

1. A pouch made from a water-soluble film, said pouch containing a composition comprising a C₅-C₂₀ polyol having at least two polar groups that are separated from each other by at least 5 carbon atoms.

2. A pouch according to claim 1 wherein the C₅-C₂₀ polyol has at least two polar groups that are separated from each other by at least 6 carbon atoms.

3. A pouch according to claim 1 wherein the polyol is selected from those having from C₅-C₁₀ polyols.

4. A pouch according to claim 1 wherein the polyol is selected from 1,4 Cyclo Hexane Di Methanol, 1,6 Hexanediol, 1,7 Heptanediol and mixtures thereof.

5. A pouch according to claim 1 wherein the polyol is 1,4 Cyclo Hexane Di Methanol.

6. A pouch according to claim 1 wherein the composition is a liquid detergent composition.

7. A pouch according to claim 3 wherein the composition is a liquid detergent composition.

8. A pouch according to claim 1 wherein the composition comprises from 0.5% to 5%, by weight of the composition, of the polyol.

9. A pouch according to claim 1 wherein the composition additionally comprises a hydrotrope.

10. A pouch according to claim 9 wherein the hydrotrope is selected from sodium cumene sulphonate, sodium xylene sulphonate, sodium naphthalene sulphonate, sodium p-toluene sulphonate, and mixtures thereof.

11. A method of producing a pouch according to claim 1.

12. The use of a pouch according to claim 1 for laundering fabrics.

13. The use of a C₅-C₂₀ polyol for aiding the dissolution of a water-soluble pouch.

14. A pouch according to claim 1 wherein the composition further comprises an anionic surfactant.

15. A pouch according to claim 1 wherein the composition further comprises an enzyme.

16. A pouch according to claim 1 wherein the composition further comprises a suds suppressor.

17. A composition useful for aiding in the dissolution of a water-soluble pouch, comprising a C₅-C₂₀ polyol, wherein the composition is contained within a pouch and said pouch comprises a water soluble film.

18. A composition according to claim 17 wherein the composition comprises from 0.5% to 5%, by weight of the composition, of the polyol.

19. A composition according to claim 17 wherein the composition further comprises from 0.25% to 10%, by weight of the composition, of a cyclic hydrotrope.

20. A composition according to claim 17 wherein the composition further comprises an anionic surfactant.
